(19) United States
(12) Patent Application Publication
(10) Pub. No.: US 2025/0118928 A1
(43) Pub. Date: Apr. 10, 2025

(54) INSULATOR WITH EXTERNAL SURFACE CONFIGURED TO REDUCE ELECTRICAL STRESS CONCENTRATIONS

(71) Applicant: G & W Electric Company, Bolingbrook, IL (US)

(72) Inventors: Foster Pyle, Oswego, IL (US); Brian Nault, Lockport, IL (US); Stefan Micic, Bolingbrook, IL (US); Blair Kerr, Downers Grove, IL (US); Kennedy Darko, Bolingbrook, IL (US)

(21) Appl. No.: 18/482,484

(22) Filed: Oct. 6, 2023

(51) Int. Cl. H01R 13/53

(52) U.S. Cl. CPC H01R 13/53

(57) ABSTRACT

An electrical bushing includes a conductor extending along a longitudinal axis and an insulating body surrounding at least a portion of the conductor. The insulating body includes a first end, a second end opposite the first end, and a plurality of sheds extending away from the longitudinal axis between the first end and the second end. The insulating body further includes a recess extending into the insulating body from the first end. The recess defines a female connection interface in communication with the conductor. The insulating body further includes an outer surface extending from the first end to a first shed of the plurality of sheds. The outer surface is configured such that electrical stresses on the outer surface vary by 25% or less along an entire length of the outer surface when the conductor is energized to a non-zero potential.

### BACKGROUND

The present invention relates to electrical insulators for applications including, for example, high voltage electrical systems. Electrical insulators, such as bushings, may, for example, serve as cable terminations, and typically include insulating material surrounding a high voltage conductor. The insulating material can be made of various generally non-conductive materials, such as porcelain, ceramic, or polymer-based materials.

### SUMMARY

It is desirable to minimize the size and thickness of the insulating material to reduce the weight, cost, and size of the insulator. However, sufficient insulation must be maintained to avoid high electrical stress concentrations, which may result in a breakdown of the insulation, partial discharges, or other electrical failures. The present disclosure provides, among other things, an insulator with reduced electrical stress concentrations, resulting in reliable insulation performance with less insulating material compared to conventional insulators.

For example, in one aspect, the disclosure provides an electrical bushing comprising a conductor extending along a longitudinal axis and an insulating body surrounding at least a portion of the conductor. The insulating body includes a first end, a second end opposite the first end, and a plurality of sheds extending away from the longitudinal axis between the first end and the second end of the insulating body. The insulating body further includes a recess extending into the insulating body from the first end. The recess defines a female connection interface in communication with the conductor. The insulating body further includes an outer surface extending from the first end to a first shed of the plurality of sheds. The outer surface is configured such that electrical stresses on the outer surface vary by 25% or less along an entire length of the outer surface when the conductor is energized to a non-zero potential.

In another aspect, the disclosure provides an electrical bushing comprising a conductor extending along a longitudinal axis and an insulating body surrounding at least a portion of the conductor. The insulating body includes a first end, a second end opposite the first end, and a recess extending into the insulating body from the first end. The recess defines a female connection interface in communication with the conductor. The insulating body further includes an outer surface including a curved portion extending from the first end and a linear portion extending from the curved portion. The outer surface is configured such that electrical stresses on the outer surface vary by 25% or less along an entire length of the outer surface when the conductor is energized to a non-zero potential.

In another aspect, the disclosure provides an electrical bushing comprising a conductor extending along a longitudinal axis and an insulating body surrounding at least a portion of the conductor. The insulating body includes a first end, a second end opposite the first end, and a plurality of sheds extending away from the longitudinal axis between the first end and the second end of the insulating body. The insulating body further includes a first recess extending into the insulating body from the first end. The recess defines a female connection interface in communication with the conductor. The insulating body further includes a second recess adjacent the first recess and an outer surface extending from the first end to a first shed of the plurality of sheds. The outer surface includes a first curved portion extending from the first end, a linear portion extending from the first curved portion, and a second curved portion extending from the linear portion to the first shed. The electrical bushing further comprises a semi-conductive insert received within the second recess. The semi-conductive insert is flush with the first end of the insulating body.

Other aspects of the invention will become apparent by consideration of the detailed description and accompanying drawings.

### BRIEF DESCRIPTION OF THE DRAWINGS

FIG. 1 is a perspective view of an electrical bushing according to an embodiment.

FIG. 2 is a cross-sectional view of the electrical bushing of FIG. 1 along the line A-A.

FIG. 3A is a bottom view of the electrical bushing of FIG. 1.

FIG. 3B is a lower perspective view of the electrical bushing of FIG. 1.

FIG. 3C is a lower perspective view of the electrical bushing of FIG. 1 with an insert removed.

FIG. 3D is a perspective view of the insert of FIG. 3C.

FIG. 4A is a cross-sectional view of a prior art electrical bushing showing electrical field lines.

FIG. 4B is a cross-sectional view of the electrical bushing of FIG. 1 showing electrical field lines.

FIG. 5A is a graph comparing electrical stress at various positions along a surface of the prior art electrical bushing of FIG. 4A and the electrical bushing of FIG. 1.

FIG. 5B is an illustration of the bushing surfaces for which electrical stress is graphed in FIG. 5A.

FIG. 6 is a perspective view of a three-phase electrical switchgear assembly including the electrical bushing of FIG. 1.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways.

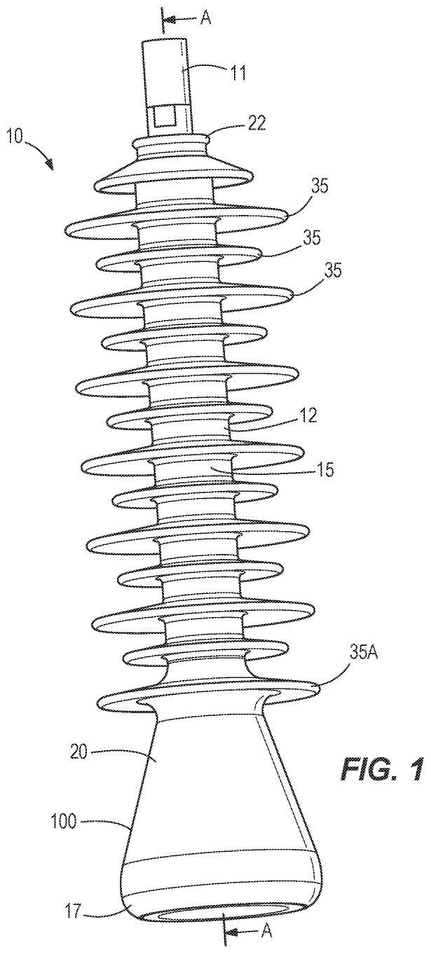

FIG. 1 illustrates an electrical insulator embodying aspects of the present disclosure. In the illustrated embodiment, the electrical insulator is an electrical bushing 10 that is operable to function in different exemplary embodiments as an electrical cable termination, an electrical terminal insulator for electrical switchgear, or more generally an electrical insulator in a variety of other applications. For example, the electrical bushing 10 may be used to conduct electricity to or from terminals of a recloser, such as the recloser disclosed in U.S. Patent Application Publication No. 2022/0216022, published Jul. 7, 2022, the entire contents of which are incorporated by reference herein.

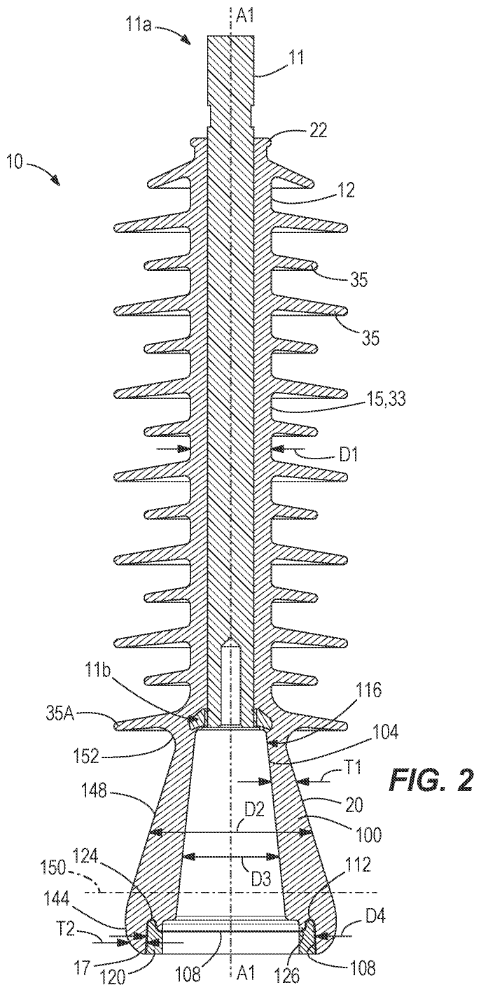

With reference to FIGS. 1 and 2, the electrical bushing 10 includes a conductive rod 11 extending along a longitudinal center axis Al of the electrical bushing 10 and having a first end 11a and a second end 11b opposite the first end 11a. The first end 11a of the illustrated conductive rod 11 is configured to be connected to an electrical conductor, such as a high-voltage cable, elbow, bus bar, or the like, and the second end 11b is configured to be connected to an electrical device, such as electrical switchgear. The conductive rod 11 is made of an electrically conductive material, such as brass or copper.

In the illustrated embodiment, the electrical bushing 10 further includes an insulating body 12 extending along the longitudinal axis Al that is fixedly coupled to the conductive rod 11. The insulating body 12 surrounds at least a portion or all of the conductive rod 11 and is made of an electrically insulative material, such as silicone rubber, silicone resin, a cured epoxy resin mixture, and the like, or a combination thereof. In some embodiments, the insulating body 12 is formed as a single, monolithic body molded around the conductive rod 11.

The insulating body 12 includes a first end 17, a first portion or base 20 extending from the first end 17, and a second portion or extension 15 extending from the base 20 to a second end 22 of the insulating body 12 opposite the first end 17 (FIG. 2). The base 20 and the extension 15 are connected together at an interface of the insulating body 12 formed by a proximal end of the base 20 and a proximal end of the extension 15. In some embodiments, a distal end of the base 20, opposite to the proximal end of the base 20, defines the first end 17 of the insulating body 12 or at least part thereof. Further, in some embodiments, a distal end of the extension 15, opposite to the proximal end of the extension 15, defines the second end 22 of the insulating body 12 or at least part thereof. In the illustrated embodiment, the conductive rod 11 extends beyond the second end 22 of the insulating body 12, such that the first end 11a of the conductive rod 11 is exposed outside of the insulating body 12. The second end 11b of the illustrated conductive rod 11 is recessed inside of the insulating body 12.

With continued reference to FIG. 2, the extension 15 includes a tubular body 33 and a plurality of sheds 35 extending from the tubular body 33 in an outward direction away from the axis A1. The sheds 35 are fixedly coupled to the tubular body 33, for example, via one or more molding processes and/or techniques. In the illustrated embodiment, the tubular body 33 defines a first diameter (e.g., an outer diameter) D1 that is substantially constant along the length of the tubular body 33, but in some embodiments, the first diameter D1 may vary. Each shed 35 is defined by a substantially flat plate in a ring-like form. In the illustrated embodiment, the longitudinal distance between any two adjacent sheds 35 is substantially constant. In some embodiments, the sheds 35 may be configured and supported similar to the sheds disclosed in U.S. Pat. No. 8,901,430, issued Dec. 2, 2014, the entire contents of which are incorporated by reference herein.

With continued reference to FIG. 2, the base 20 of the insulating body 12 includes an outer surface 100 defining a second diameter (e.g., an outer diameter) D2 different from the first diameter D1, which varies along a length (i.e., in a direction along the center axis A1 of FIG. 2) of the base 20. For example, the second diameter D2 of the outer surface increases and/or decreases along the length of the base 20. In some embodiments, the second diameter D2 is greater than the first diameter D1 at all points across the base 20. A first recess (e.g., a conically-shaped recess) 104 extends into the base 20 of the insulating body 12 in a direction along the center axis A1. An inner wall or surface of the insulating body 12 defining the first recess 104 has a third diameter (e.g., an inner diameter) D3 that varies along the center axis A1. More specifically, in the illustrated embodiment, the third diameter D3 narrows in a direction toward the second end 22 of the insulating body 12 such that the first recess 104 forms a truncated cone.

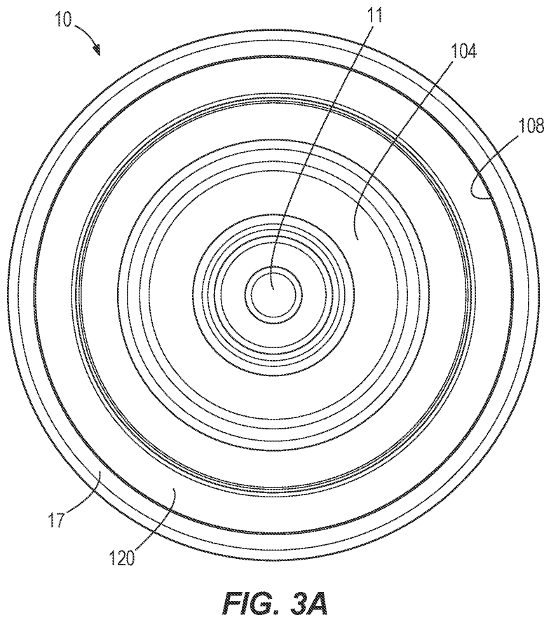

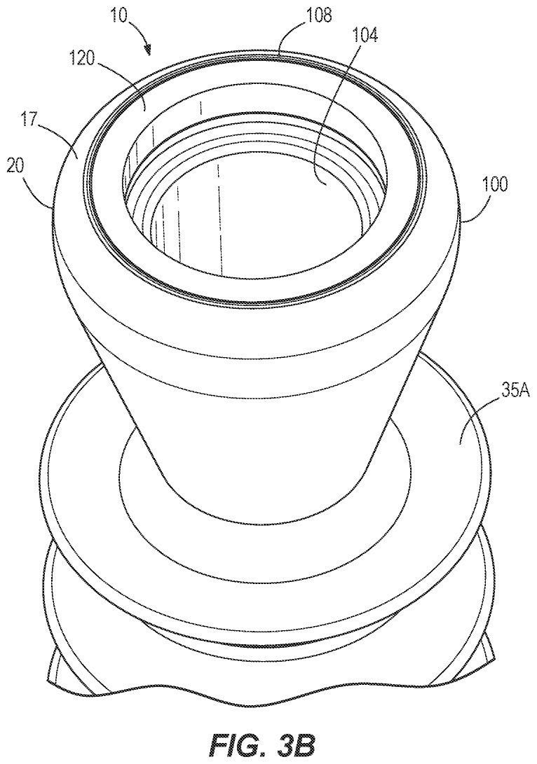

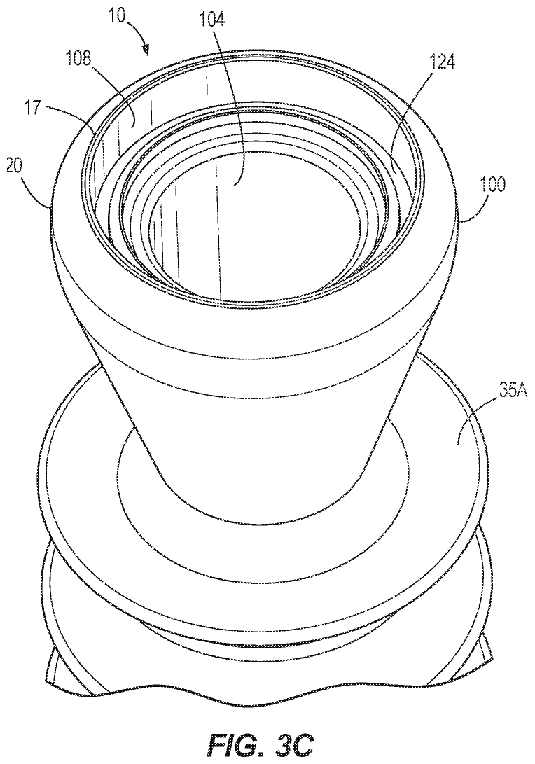

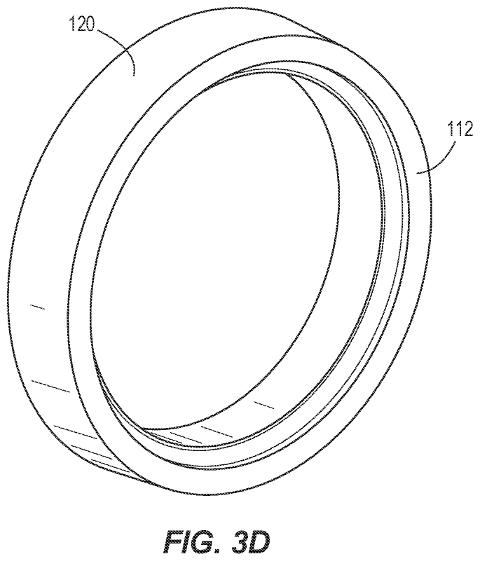

The first recess 104 defines a female connection interface 116 in communication with the second end 11b of the conductive rod 11. In some embodiments, the female connection interface 116 is an IEEE compliant connection interface. In particular, the female connection interface 116 is configured to receive a correspondingly shaped male connection interface (not shown) on, for example, the electrical device to connect a terminal of the electrical device to the second end 11b of the conductive rod 11. In the illustrated embodiment, a second recess (e.g., an annular recess) 108 also extends into the base 20 of the tubular body in the same direction along the center axis A1 relative to the first recess 104. The second recess 108 is adjacent the first recess 104. In some embodiments, the first and second recesses 104 and 108 in the base 20 are substantially concentric about the center axis A1. In the illustrated embodiment, the first recess 104 and the second recess 108 are aligned with the center axis A1. The second recess 108 has a fourth diameter (e.g., an inner diameter) D4 that is sized to receive an insert 120 (FIG. 3D) of the electrical bushing 10. In the illustrated embodiment, the fourth diameter D4 is larger than the third diameter D3. To facilitate retaining the insert 120, the second recess 108 includes a groove (e.g., an annular groove) 124 (FIG. 3C) in the base 20 that extends around an inner end of the second recess 108, such that an annular protrusion 126 formed between the first and second recesses 104 and 108 protrudes along the axis A1 toward the first end 17 of the base 20.

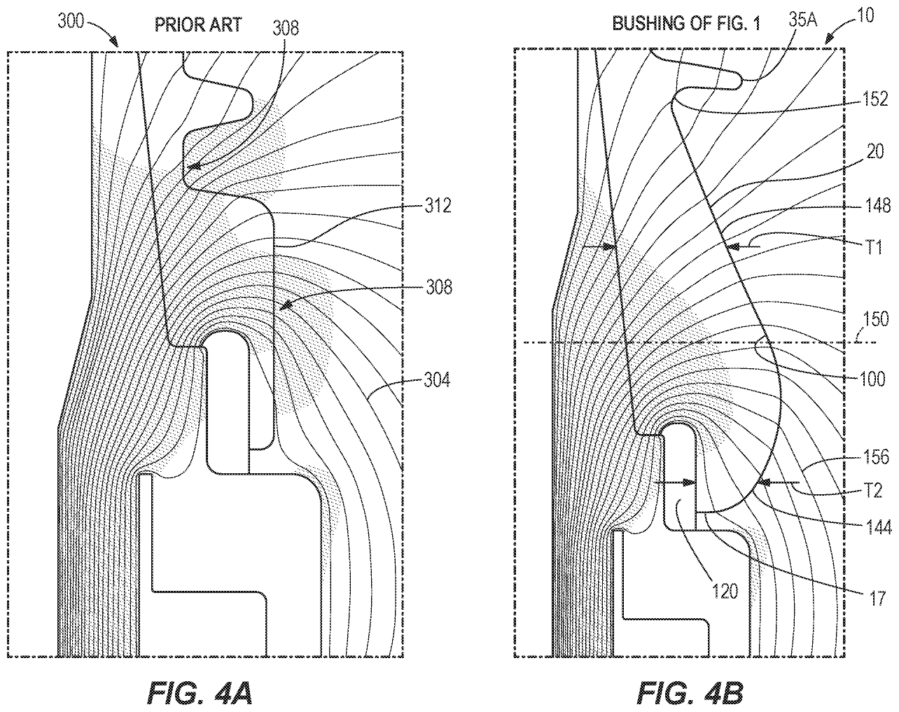

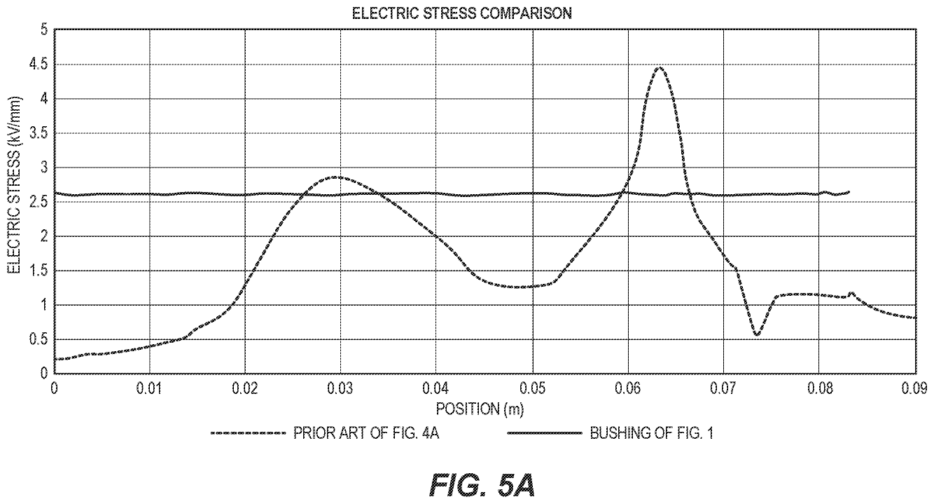

With reference to FIGS. 2, 3A, 3B, 3C, and 3D, the insert 120 received in the second recess 108 is made of semi-conductive material, which may be semi-conductive silicone in some embodiments. In the illustrated embodiment, the insert 120 is sized and shaped to fit within both the second recess 108 and the groove 124, such that the insert 120 includes an annular projecting portion 112 (sometimes referred to as an annular projection) that fits within, and in some embodiments fills, the groove 124 and that is narrower than the remainder of the insert 120. In the illustrated embodiment, the insert 120 is substantially flush with the first end 17 of the insulating body 12 and is securely held within the second recess 108. In some embodiments, an end of the insert 120, adjacent the first end 17 of the insulating body 12, is spaced from the first end 17 of the insulating body 12 by about 0.062 inches or less. Further, in the illustrated embodiment, the annular projecting portion 112 is engaged with the annular protrusion 126 and an inner wall of the insulating body 12 defining the second recess 108. In operation, the insert 120 performs an electrical field grading function. More specifically, the insert 120 directs electrical field lines 156 (see FIG. 4B) around the insert 120 to at least partly shape the electrical field lines 156 as desired.

As described in greater detail below and illustrated in FIGS. 1 and 2, the base 20 is sized and shaped in a manner that provides relatively constant electrical stress on the outer surface 100 of the base 20 when the electrical bushing 10 is in operation (i.e., when the conductive rod 11 is energized). With reference to FIG. 2, the illustrated outer surface 100 includes a first curved portion 144 extending from the first end 17, a linear portion 148 extending from the first curved portion 144, and a second curved portion 152 extending from the linear portion 148 in a direction from the first end 17 towards the first shed 35A. The profile of the constant stress portion 100 avoids sharp bends as encountered with prior art bushings. The first curved portion 144 and the second curved portion 152 curve in opposite directions. For example, the first curved portion 144 is substantially concave, while the second curved portion 152 is substantially convex. The linear portion 148 is sloped inwardly toward the center axis A1 in a direction from the first end 17 toward the first shed 35A. A first thickness T1 of the insulating body 12, and more specifically, of the base 20, is defined as a distance between an outer edge of the first recess 104 and the outer surface 100 of the base 20. The first thickness T1 of the base 20 thus decreases in a direction from the first end 17 to the first shed 35A along the linear portion 148. On the other hand, in some embodiments, an area of the base 20 corresponding to the first curved portion 144 has a second thickness T2 that is different from the first thickness T1. The second thickness T2 of the base 20 is defined as a distance between (a) an outer edge of the second recess 108 and/or the groove 124 and (b) the outer surface 100 of the base 20. In such embodiments, the second thickness T2 increases in a direction from the first end 17 toward the linear portion 148 along the first curved portion 144. In the illustrated embodiment, the first thickness T1 is substantially equal to the second thickness T2 at an interface 150 of the first curved portion 144 and the linear portion 148.

In some embodiments, to achieve target performance characteristics of the electrical bushing 10, the profile of the constant stress portion 100 is determined in connection with performing one or more computer-implemented calculations associated with finite element analysis (FEA). Such calculations may be based on, for example, any one of (a) a parameter of the female connection interface 116, (b) a material characteristic of the insulating body 12, (c) a voltage applied to the conductive rod 11, and (d) the like, or (e) a combination thereof.

FIG. 4A illustrates a distribution of electrical field lines 304, which results in undesirable electrical stress concentrations 308 along a surface 312 of a prior art device 300. In contrast, FIG. 4B illustrates a distribution of electrical field lines 156 produced during operation of the electrical bushing 10. As illustrated, the electric field lines 156 associated with the electrical bushing 10 are relatively evenly spaced at least in part because of the configuration of the first curved portion 144, the linear portion 148, the second curved portion 152, and/or, more generally, the base 20, with reduced stress concentrations along the outer surface 100 compared to stress concentrations encountered along surface 312 in prior art bushing 300.

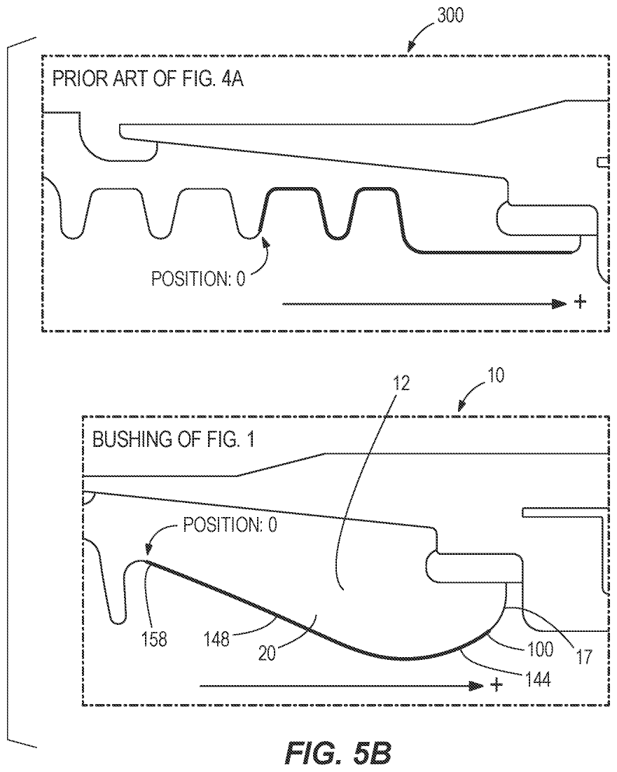

With reference to the graphs of FIGS. 5A and 5B, the FIG. 5A graph plots electrical stress on the Y-axis in kV/mm as a function of position, which is plotted on the X-axis. Position is measured along the surface of the base 20 of the bushing 10 as illustrated in FIG. 5B and also along an analogous portion of the prior art device 300 of FIG. 4A. Under the electrical loading applied in the graph of FIG. 5A, the base 20 of the bushing 10 of FIG. 1 experienced a relatively constant electrical stress of approximately 2.6 kV/mm along the entire outer surface 100 of the base 20. In contrast, the prior art device 300 of FIG. 4A experienced a varying range of electrical stresses ranging from approximately 0.2 kV/mm to a peak of approximately 4.5 kV/mm along its length resulting in regions of unwanted high electrical stress. With reference to FIG. 5B, for the purposes of the graph of FIG. 5A, the position measured along the base 20 of the electrical bushing 10 is designated to be zero at a location 158 (with reference to FIG. 2, the location 158 is near the second curved portion 152), and the position increases in the positive direction when moving along the surface of the insulating body 12 away from the location 158 and toward the first end 17.

Thus, the illustrated bushing 10 is configured such that electrical stresses on the outer surface 100 of the base 20 vary in magnitude by 25% or less (i.e., between 0% and 25%) of the average electrical stress along the outer surface 100 when the conductive rod 11 is energized to a non-zero potential (e.g., a voltage greater than 1,000 Volts, such as 38 kV or 72.5 kV in some embodiments). Additionally or alternatively, in some embodiments, the electrical bushing 10 is similarly configured such that the electrical stresses on the outer surface 100 of the base 20 vary in magnitude by 15% or less when the conductive rod 11 is energized to a non-zero potential. Additionally or alternatively, in some embodiments, the electrical bushing 10 is configured such that the electrical stresses on the outer surface 100 of the base 20 vary in magnitude by 5% or less when the conductive rod 11 is energized to a non-zero potential.

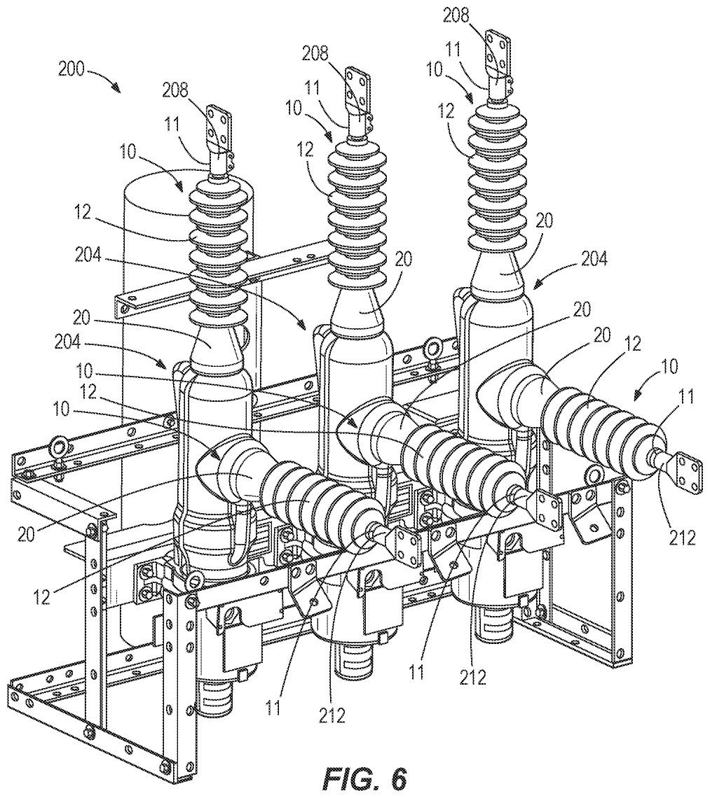

With reference to FIG. 6, an electrical switchgear assembly 200 is a three-phase electrical recloser that may be energized with various voltages (e.g., a voltage greater than 1,000 Volts, such as 38 kV or 72.5 kV in some embodiments). In some embodiments, the electrical switchgear assembly 200 is a medium or high-voltage solid-dielectric recloser 200 and may have another number of electrical phases such as one or two. The illustrated electrical switchgear assembly 200 includes interrupter assemblies 204, which in the illustrated embodiment are vacuum interrupter assemblies 204, that selectively connect and disconnect conductors 208 and respective conductors 212. Tripping operation of the electrical switchgear assembly 200 can be driven by means of actuator output and/or, in some instances, mechanical energy (e.g., spring energy) stored via one or more mechanisms of the electrical switchgear assembly 200. In some embodiments, the conductors 208 are load-side conductors, and the conductors 212 are source-side conductors, and in other embodiments, the conductors 208 are source-side conductors, and the conductors 212 are load-side conductors. The illustrated switchgear device 200 includes six electrical bushings 10, but other embodiments may include different numbers of electrical bushings 10. In the illustrated embodiment, the conductors 208, 212 include the conductive rods 11 of the electrical bushings 10, and each conductive rod 11 is electrically insulated by an insulating body 12.

Various features and advantages of the invention are set forth in the following claims.

What is claimed is:

1. An electrical bushing comprising:
a conductor extending along a longitudinal axis; and
an insulating body surrounding at least a portion of the conductor, the insulating body including
a first end,
a second end opposite the first end,
a plurality of sheds extending away from the longitudinal axis between the first end and the second end of the insulating body,
a recess extending into the insulating body from the first end, the recess defining a female connection interface in communication with the conductor, and
an outer surface extending from the first end to a first shed of the plurality of sheds, wherein the outer surface is configured such that electrical stresses on the outer surface vary by 25% or less along an entire length of the outer surface when the conductor is energized to a non-zero potential.

2. The electrical bushing of claim 1, wherein the recess is a first recess, wherein the insulating body further includes a second recess adjacent the first recess, and wherein the electrical bushing further comprises an insert received within the second recess.

3. The electrical bushing of claim 2, wherein the insert is semi-conductive.

4. The electrical bushing of claim 2, wherein the insert is flush with the first end of the insulating body.

5. The electrical bushing of claim 2, wherein the insert includes an annular projection extending toward the second end of the insulating body.

6. The electrical bushing of claim 1, wherein the outer surface includes a curved portion extending from the first end and a linear portion extending from the curved portion.

7. The electrical bushing of claim 6, wherein the insulating body includes a first thickness that decreases along the linear portion in a first direction from the first end of the insulating body toward the first shed of the plurality of sheds, and wherein the insulating body includes a second thickness that increases along the curved portion in the same direction.

8. The electrical bushing of claim 7, wherein the first thickness is equal to the second thickness at an interface of the curved portion and the linear portion.

9. An electrical switchgear including an interrupter assembly and the electrical bushing of claim 1.

10. An electrical bushing comprising:
a conductor extending along a longitudinal axis; and
an insulating body surrounding at least a portion of the conductor, the insulating body including
a first end,
a second end opposite the first end,
a recess extending into the insulating body from the first end, the recess defining a female connection interface in communication with the conductor, and
an outer surface including a curved portion extending from the first end and a linear portion extending from the curved portion, wherein the outer surface is configured such that electrical stresses on the outer surface vary by 25% or less along an entire length of the outer surface when the conductor is energized to a non-zero potential.

11. The electrical bushing of claim 10, wherein the recess is a first recess, wherein the insulating body further includes a second recess adjacent the first recess, and wherein the electrical bushing further comprises an insert received within the second recess.

12. The electrical bushing of claim 11, wherein the insert is semi-conductive.

13. The electrical bushing of claim 11, wherein the insert is flush with the first end of the insulating body.

14. The electrical bushing of claim 11, wherein the insert includes an annular projection extending toward the second end of the insulating body.

15. The electrical bushing of claim 10, wherein the outer surface includes a second curved portion extending from the linear portion.

16. The electrical bushing of claim 15, wherein the linear portion is sloped inwardly toward the longitudinal axis in a direction from the first end toward the second end.

17. The electrical bushing of claim 16, wherein a thickness of the insulating body decreases along the linear portion in the direction from the first end toward the second end.

18. The electrical bushing of claim 10, wherein the non-zero potential is greater than 1,000 Volts.

19. An electrical bushing comprising:
a conductor extending along a longitudinal axis;
an insulating body surrounding at least a portion of the conductor, the insulating body including
a first end,
a second end opposite the first end,
a plurality of sheds extending away from the longitudinal axis between the first end and the second end of the insulating body,
a first recess extending into the insulating body from the first end, the recess defining a female connection interface in communication with the conductor,
a second recess adjacent the first recess, and
an outer surface extending from the first end to a first shed of the plurality of sheds, wherein the outer surface includes a first curved portion extending from the first end, a linear portion extending from the first curved portion, and a second curved portion extending from the linear portion to the first shed; and
a semi-conductive insert received within the second recess, wherein the semi-conductive insert is flush with the first end of the insulating body.

20. The electrical bushing of claim 19, wherein the linear portion is sloped inwardly toward the longitudinal axis in a direction from the first end toward the second end, and wherein a thickness of the insulating body decreases along the linear portion in the direction from the first end toward the second end.

21. The electrical bushing of claim 19, wherein the first recess has a first diameter transverse to the longitudinal axis, wherein the second recess has a second diameter transverse to the longitudinal axis, and wherein the first diameter is greater than the second diameter.

22. The electrical bushing of claim 19, wherein the second recess has a first end proximal the first end of the insulating body and a second opposite end adjacent the first recess, and wherein the electrical bushing further comprises a groove that extends around the second end of the second recess and is configured to receive an annular projection formed on the insert.

23. The electrical bushing of claim 19, wherein the linear portion is sloped outwardly from the longitudinal axis in a direction from the first shed toward the first end.
